(19) United States
(12) Patent Application Publication
(10) Pub. No.: US 2025/0267576 A1
(43) Pub. Date: Aug. 21, 2025

(54) Wireless Communication Method and Device thereof

(71) Applicant: ZTE Corporation, Shenzhen (CN)

(72) Inventors: Jianqiang DAI, Shenzhen (CN); Bo DAI, Shenzhen (CN); Jun XU, Shenzhen (CN); Mengzhu CHEN, Shenzhen (CN); Xiaoying MA, Shenzhen (CN)

(21) Appl. No.: 18/856,691

(22) PCT Filed: Apr. 12, 2022
(86) PCT No.: PCT/CN2022/086400

§ 371 Date: Oct. 14, 2024

(51) Int. Cl. H04W 52/02; H04W 76/28

(52) U.S. Cl. CPC H04W 52/0219; H04W 52/028; H04W 76/28

(57) ABSTRACT

A wireless communication method for use in a wireless terminal is disclosed. The method comprises receiving, from a wireless network node, a radio resource control, RRC, signaling indicating that a discontinuous reception, DRX, group is configured by using a plurality of DRX configurations, and using DRX parameters configured by using the plurality of DRX configurations to perform a DRX operation for the DRX group, wherein start offsets of the plurality of DRX configurations are different

This document is directed generally to wireless communications, and in particular to an indication of configuration of discontinuous reception (DRX).

In extended reality (XR) or Cloud Gaming (CG) scenarios, downlink traffic or uplink video stream arrives in quasi-periodic manner. The periodicity may be a non-integer. For example, the periodicity of XR traffic is 1/fps on average, e.g., is 16.67 ms @ fps=60 (fps: frames per second).

In order to save energy consumption at the device (i.e. the user equipment, UE), the DRX is used in both LTE and NR. The RRC (radio resource control) controls a DRX operation by configuring the following parameters:
drx-onDurationTimer: the duration at the beginning of a DRX cycle;
drx-SlotOffset: the delay before starting the drx-onDuration Timer;
drx-InactivityTimer: the duration after the PDCCH occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;

Note that the prefix of each parameter may be omitted in the present disclosure. For example, the drx-onDurationTimer is also named as onDurationTimer in this regard.

In addition, the drx-onDurationTimer and/or drx-InactivityTimer may be a duration or an exact timer that may run in the duration.

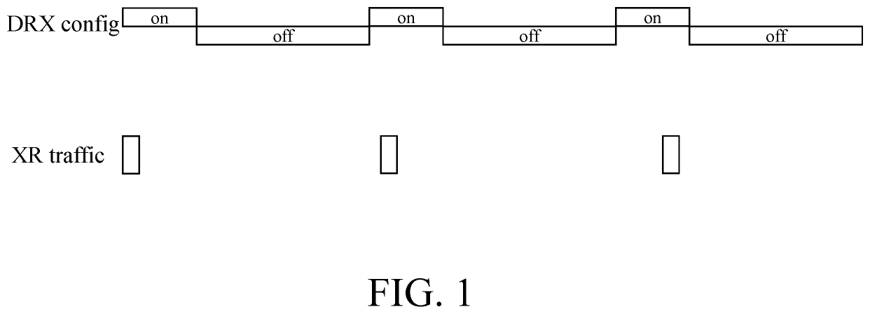

A DRX cycle consists of a period of DRX-on state and an interval of DRX-off state, which means the UE is not required to monitor a physical downlink control channel (PDCCH) during the DRX-off state so that the power for detecting the PDCCH can be saved. For example, as shown in FIG. 1, the XR downlink traffic arrives when the UE is in the DRX-on state. Thus, the gNB can deliver the PDCCH for scheduling the DL packets. On the receiver (UE) side, the PDCCH can be monitored, and the packet may be successfully decoded based on the detected PDCCH.

However, the current periodicity of the DRX is defined to be an integer different from that of the XR traffic. The difference leads to an issue of mismatched periodicity between the service and the DRX configuration. In other words, with the current DRX configuration, the XR traffic may arrive at the time interval of the DRX-off state. Under such conditions, the UE's active time may increase and the corresponding power consumption is raised, resulting in a particular problem if the device is powered by battery.

This document relates to methods, systems, and devices for indication of the configuration of discontinuous receiving.

The present disclosure relates to a wireless communication method for use in a wireless terminal. The method comprises:
receiving, from a wireless network node, a radio resource control, RRC, signaling indicating that a discontinuous reception, DRX, group is configured by using a plurality of DRX configurations, and
using DRX parameters configured by using the plurality of DRX configurations to perform a DRX operation for the DRX group,
wherein start offsets of the plurality of DRX configurations are different.

Various embodiments may preferably implement the following features:

Preferably, the RRC signaling configures a serving cell, a carrier, a group of serving cells or a media access control, MAC, entity in the DRX group configured by using the plurality of DRX configurations.

Preferably, the DRX parameters of the DRX group are configured separately based on each of the plurality of DRX configurations.

Preferably, the plurality of DRX configurations has the same DRX cycle.

Preferably, a time gap between any two start offsets of the plurality of DRX configurations are larger than a configured onduration Timer.

Preferably, at least one timer associated with the DRX group is configured separately based on each of plurality of DRX configurations, wherein the at least one timer comprises at least one of a drx-onDurationTimer, a drx-inactivity timer, or a drx-retransmission timer.

Preferably, the plurality of DRX configurations shares at least one common parameter.

Preferably, the at least one common parameter comprises at least one of a drx-onDurationTimer or a drx-inactivity timer.

Preferably, a DRX cycle of each of the plurality of DRX configuration is configured to be a multiple of 25 ms.

Preferably, a DRX cycle of each of the plurality of DRX configurations is determined based on:

$$\frac{1000}{fps} = \frac{A}{B} ,$$

where A/B is a irreducible fraction
wherein fps is a value of frames per second and the DRX cycle is configured as A.

Preferably, a DRX cycle of each of the plurality of DRX configurations is configured by:

$$drx cycle = function ( \frac{1000}{fps} ) ,$$

wherein the function is a round function, a round up function or a round down function

Preferably, the wireless communication method further comprises receiving, from the wireless network node, a wake up signal of activating or deactivating the DRX group configured by using the plurality of DRX configurations.

The present disclosure relates to a wireless communication method for use in a wireless network node. The method comprises:
transmitting, to a wireless terminal, a radio resource control, RRC, signaling indicating that a discontinuous reception, DRX, group is configured by using a plurality of DRX configurations, wherein start offsets of the plurality of DRX configurations are different.

Various embodiments may preferably implement the following features:

Preferably, the RRC signaling configures a serving cell, a carrier, a group of serving cells or a media access control, MAC, entity in the DRX group configured by using the plurality of DRX configurations.

Preferably, the DRX parameters of the DRX group are configured separately based on each of the plurality of DRX configurations.

Preferably, the plurality of DRX configurations has the same DRX cycle.

Preferably, a time gap between any two start offsets of the plurality of DRX configurations are larger than a configured onDurationTimer.

Preferably, at least one timer associated with the DRX group is configured separately based on each of plurality of DRX configurations, wherein the at least one timer comprises at least one of a drx-onDurationTimer, a drx-inactivity timer, or a drx-retransmission timer.

Preferably, the plurality of DRX configurations shares at least one common parameter.

Preferably, the at least one common parameter comprises at least one of a drx-onDurationTimer or a drx-inactivity timer

Preferably, a DRX cycle of each of the plurality of DRX configuration is configured to be a multiple of 25 ms.

Preferably, a DRX cycle of each of the plurality of DRX configurations is determined based on:

$$\frac{1000}{fps} = \frac{A}{B} ,$$

where A/B is a irreducible fraction
wherein fps is a value of frames per second and the DRX cycle is configured as A.

Preferably, a DRX cycle of each of the plurality of DRX configurations is configured by:

$$drx cycle = function ( \frac{1000}{fps} ) ,$$

wherein the function is a round function, a round up function or a round down function

Preferably, the wireless communication method further comprises transmitting, to the wireless terminal, a wake up signal of activating or deactivating the DRX group configured by using the plurality of DRX configurations.

The present disclosure relates to a wireless communication method for use in a wireless terminal. The method comprises receiving, from a wireless network node, a radio resource control signaling, indicating a discontinuous reception, DRX, group is configured with a first cycle and a second cycle.

Various embodiments may preferably implement the following features:

Preferably, the DRX group is configured with the first cycle and the second cycle by:
starting a timer of the second cycle and counting the number of second cycles after using the second cycle when starting a timer of the first cycle, wherein the second cycle is used for the DRX group.

Preferably, the DRX group is configured with the first cycle and the second cycle by:
when the number of second cycles after using the second cycle exceeds a threshold:
switching to next first cycle, and
starting the timer of the second cycle and counting the number of second cycles after using the second cycle when starting the timer of the next first cycle, wherein the second cycle is used for the DRX group.

Preferably, the DRX group is configured with the first cycle and the second cycle by:
starting a drx-onDurationTimer for the DRX group at a beginning of each second cycle timer.

Preferably, the first cycle is a drx-LongCycle and the second cycle is a drx-ShortCycle.

The present disclosure relates to a wireless communication method for use in a wireless network node. The method comprises transmitting, to a wireless terminal, a radio resource control signaling of configuring a discontinuous reception, DRX, group with a first cycle and a second cycle.

Various embodiments may preferably implement the following features:

Preferably, the DRX group is configured with the first cycle and the second cycle by:
starting a timer of the second cycle and counting the number of second cycles after using the second cycle when starting a timer of the first cycle, wherein the second cycle is used for the DRX group.

Preferably, the DRX group is configured with the first cycle and the second cycle by:
when the number of second cycles after using the second cycle exceeds a threshold:
switching to next first cycle, and
starting the timer of the second cycle and counting the number of second cycles after using the second cycle when starting the timer of the next first cycle, wherein the second cycle is used for the DRX group.

Preferably, the DRX group is configured with the first cycle and the second cycle by:
starting a drx-onDurationTimer for the DRX group at a beginning of each second cycle timer.

Preferably, the first cycle is a drx-LongCycle and the second cycle is a drx-ShortCycle.

The present disclosure relates to a wireless communication method for use in a wireless terminal. The method comprises:
receiving, from a wireless network node, a radio resource control signaling indicating a discontinuous reception, DRX, group is configured with a sub-cycle timer associated with a sub-cycle used by a DRX operation, a threshold of the number of sub-cycles in a DRX cycle and a sub-cycle offset, and
using the sub-cycle to perform the DRX operation by:
starting the sub-cycle timer and counting the number of sub-cycles in a first DRX cycle at a start of the first DRX cycle,
restarting the sub-cycle timer the sub-cycle offset after the sub-cycle timer expires,
starting a drx-onDurationTimer at a beginning of each sub-cycle timer, and
starting a second DRX cycle after the number of sub-cycles in the first DRX cycle exceeds the threshold.

The present disclosure relates to a wireless communication method for use in a wireless terminal. The method comprises:
receiving, from a wireless network node, a radio resource control signaling indicating a discontinuous reception (DRX) group is configured with a first sub-cycle timer associated with a first sub-cycle used by a DRX operation, a second sub-cycle timer associated with a second sub-cycle used by the DRX operation, and a threshold of the number of first sub-cycles in a DRX cycle, and
performing the DRX operation by:
starting a drx-onDurationTimer, the first sub-cycle timer and counting the number of first sub-cycles in a DRX cycle at a start of the DRX cycle,
if the first sub-cycle timer expires and the number of first sub-cycles in the first DRX cycle does not exceed the threshold:
restarting the drx-onDurationTimer in the first symbol after the first sub-cycle timer expires, and
restarting the first sub-cycle timer, and
if the first sub-cycle timer expires and the number of first sub-cycles in the first DRX cycle exceeds the threshold:
starting the second sub-cycle timer and the drx-onDuration Timer,
restarting the drx-onDurationTimer in the first symbol after the second sub-cycle timer expires and restarting the second sub-cycle time when in the DRX-cycle, and
switching to a first sub-cycle after the DRX-cycle ends.

The present disclosure relates to a wireless communication method for use in a wireless terminal. The method comprises:
using a first discontinuous reception, DRX, configuration comprising a configured cycle number to perform a DRX operation, and
switching to use a second DRX configuration to perform the DRX operation after the number of cycles of using the first DRX configuration to perform the DRX operation exceeds the configured cycle number.

Various embodiments may preferably implement the following feature:

Preferably, the method further comprises receiving, from a wireless network node, a radio resource control signaling indicating the first DRX configuration.

The present disclosure relates to a wireless communication method for use in a wireless network node. The method comprises:
transmitting, to a wireless terminal, a radio resource control signaling indicating a first discontinuous reception, DRX, configuration,
wherein the first DRX configuration comprises a configured cycle number indicating the number of cycles of using the first DRX configuration to perform a DRX operation before switching to use a second DRX configuration to perform the DRX operation.

In the present disclosure, at least one parameter in each DRX configuration is determined based on at least one variable having a time unit smaller than a subframe.

Preferably, the time unit comprises a slot and/or a symbol.

Preferably, the at least one parameter comprises at least one of a start offset for a long cycle or a start offset for a short cycle.

Preferably the start offset for the long cycle or the start offset for the short cycle is determined by:

$$[ ( SFN \times 10 ) + subframe number + slot number + symbol number ] modulo ( drx cycle )$$

wherein SFN is a system frame number.

The present disclosure relates to a wireless terminal. The wireless terminal comprises:
a communication unit, configured to receive, from a wireless network node, a radio resource control, RRC, signaling indicating that a discontinuous reception, DRX, group is configured by using a plurality of DRX configurations, and
a processor, configured to use DRX parameters configured by using the plurality of DRX configurations to perform a DRX operation for the DRX group, wherein start offsets of the plurality of DRX configurations are different.

Various embodiments may preferably implement the following feature:

Preferably, the processor is further configured to perform any of aforementioned wireless communication methods.

The present disclosure relates to a wireless network node. The wireless network node comprises a communication unit, configured to transmit, to a wireless terminal, a radio resource control, RRC, signaling indicating a discontinuous reception, DRX, group is configured by using a plurality of DRX configurations, wherein start offsets of the plurality of DRX configurations are different.

Various embodiments may preferably implement the following feature:

Preferably, the wireless network node further comprises a processor configured to perform any of aforementioned wireless communication methods.

The present disclosure relates to a wireless terminal. The wireless terminal comprises:
a communication unit, configured to receive, from a wireless network node, a radio resource control signaling, indicating a discontinuous reception, DRX, group is configured with a first cycle and a second cycle.

Various embodiments may preferably implement the following feature:

Preferably, the wireless terminal further comprises a processor configured to perform any of aforementioned wireless communication methods.

The present disclosure relates to a wireless network node. The wireless network node comprises:
a communication unit, configured to transmit, to a wireless terminal, a radio resource control signaling, indicating a discontinuous reception, DRX, group is configured with a first cycle and a second cycle.

Various embodiments may preferably implement the following feature:

Preferably, the wireless terminal further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

FIG. 1 shows a schematic diagram of a periodicity mismatch between DRX configuration and XR traffic according to an embodiment of the present disclosure.

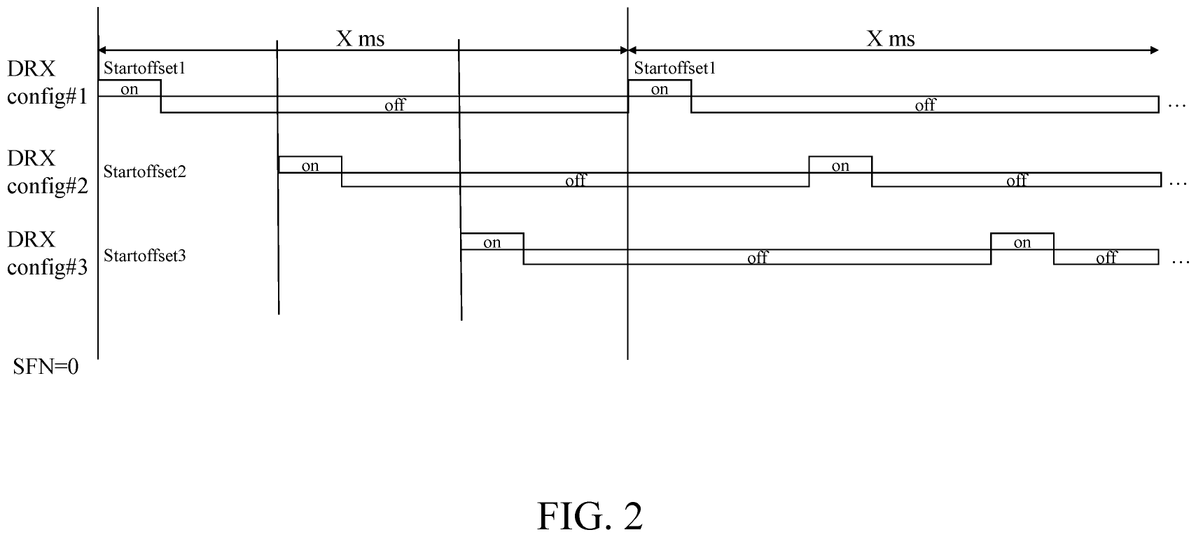

FIG. 2 shows a schematic diagram of multiple DRX configurations for a serving cell according to an embodiment of the present disclosure.

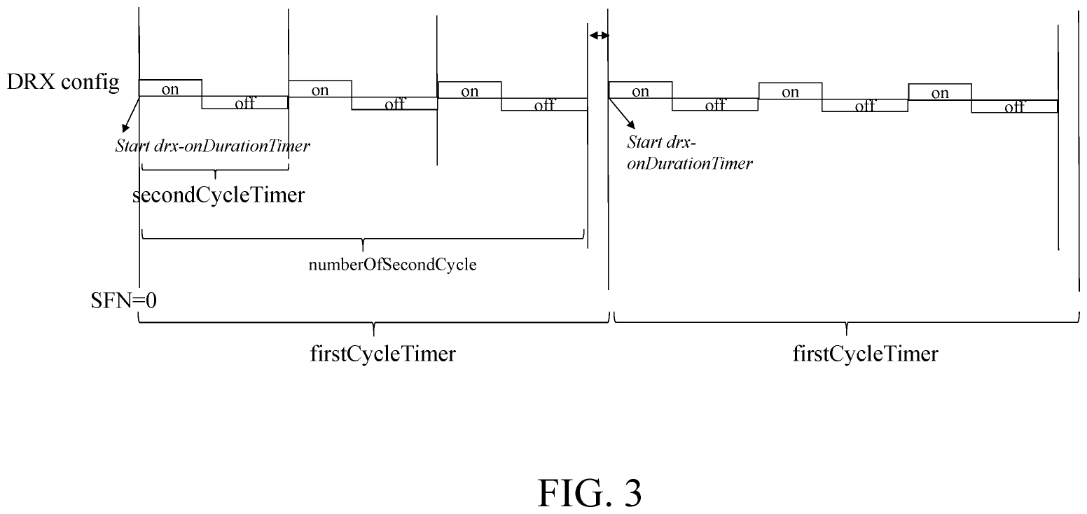

FIG. 3 shows a schematic diagram according to an embodiment of the present disclosure.

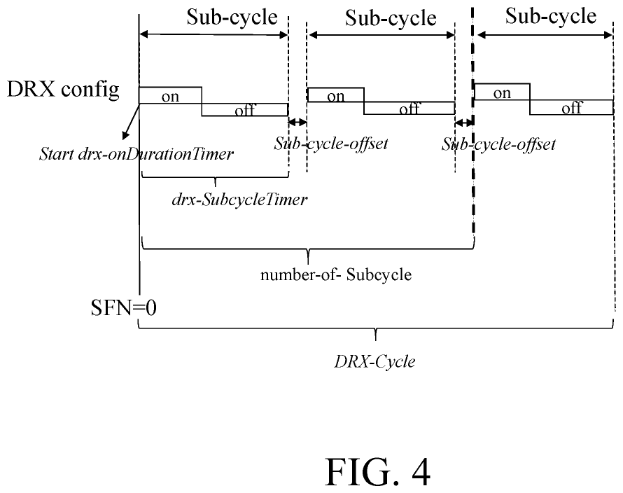

FIG. 4 shows a schematic diagram according to an embodiment of the present disclosure.

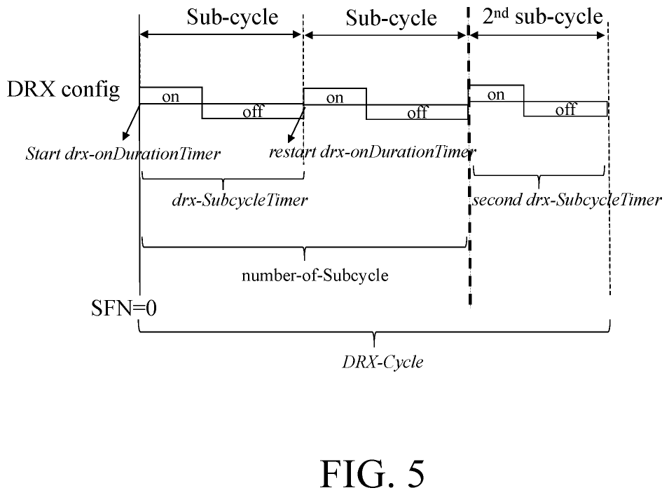

FIG. 5 shows a schematic diagram of a switch between different sub DRX-cycles according to an embodiment of the present disclosure.

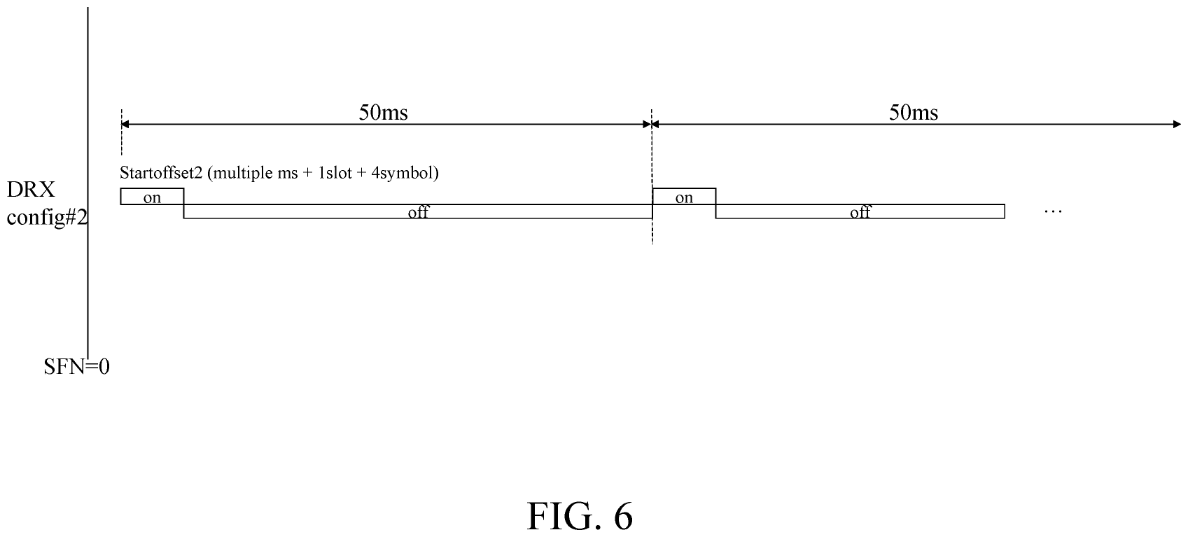

FIG. 6 shows a schematic diagram according to an embodiment of the present disclosure

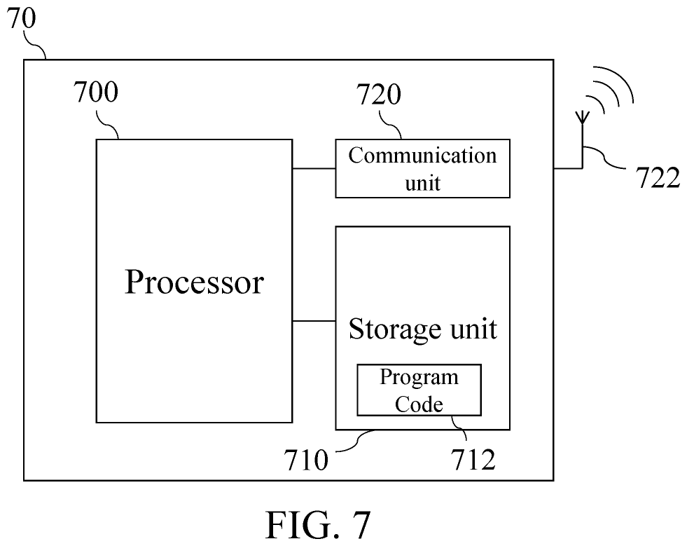

FIG. 7 shows an example of a schematic diagram of a wireless terminal according to an embodiment of the present disclosure.

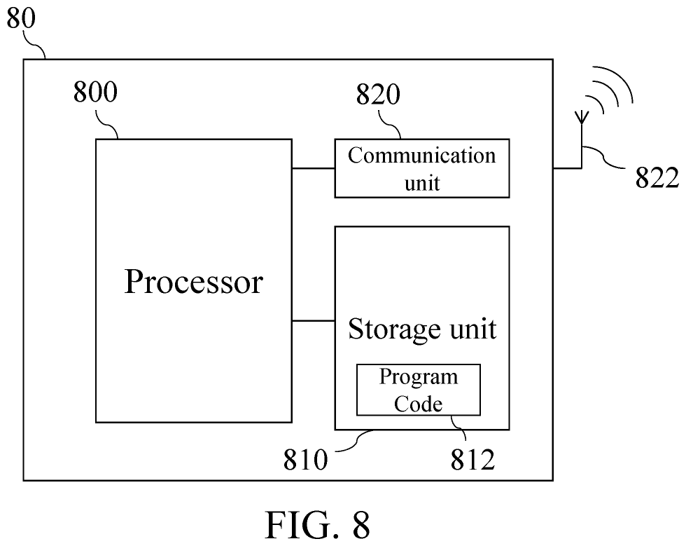

FIG. 8 shows an example of a schematic diagram of a wireless network node according to an embodiment of the present disclosure.

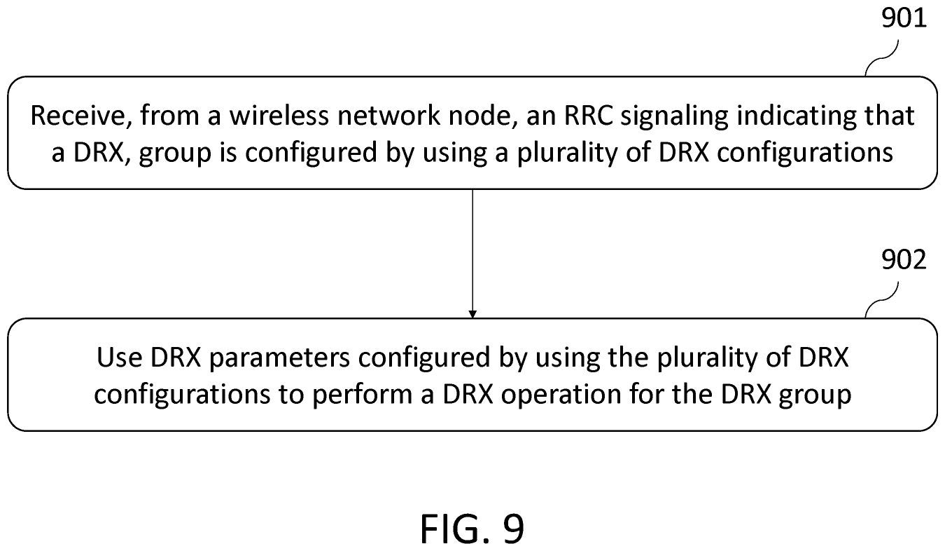

FIGS. 9 to 16 show flowcharts of methods according to some embodiments of the present disclosure.

FIG. 1 shows a schematic diagram of a periodicity mismatch between DRX configuration and XR traffic according to an embodiment of the present disclosure.

The periodicity of DRX and the periodicity of XR traffic are quasi-aligned, given there is RRC configuration for the CDRX. Although they are not aligned exactly in each traffic cycle, they achieve time alignment in terms of every several traffic cycles.

In an example, a serving cell or a serving cells group or a MAC entity can be configured by the RRC with multiple DRX configurations. In this way, the periodicities of the DRX and traffic can reach alignment at the end of each cycle of a DRX configuration.

In an embodiment shown in FIG. 2, multiple DRX configurations are configured for a serving cell/carrier for a UE. Basically, the UE goes into the DRX-on state or the DRX-off state according to each configured DRX configuration via the RRC signaling, i.e., in a semi-static manner.

Specifically, for each DRX configuration (e.g., for each of DRX config #1, DRX config #2 and DRX config #3 shown in FIG. 2) it is assumed that the periodicity of the DRX is X ms. The UE starts an onDurationTimer after a time offset from the beginning of the subframe, wherein the time offset is defined by a DRX parameter StartOffset in each DRX configuration. The UE is in the DRX-on state when onDurationTimer is running for each cycle.

Meanwhile, in the X ms period, there are additional DRX-on times which are configured by other DRX configurations. As a result, for the pattern as shown in FIG. 2, three segments of onDuration intervals (i.e. “on” Blocks) are configured within a window of X ms (e.g. the drx-LongCycle may be X=50 ms). In this embodiment, the StartOffsets in the DRX configurations are different.

Thus, for the UE, if multiple DRX configurations are configured for a serving cell/carrier, the UE is in an active time state when the onDurationTimer, and optionally an Inactive Timer of any one of the multiple DRX configurations, is running.

In an embodiment, multiple DRX configurations are configured for a serving cell/carrier, or per cell group/per MAC entity for a UE. For example, a group of Serving Cells is configured by RRC and the Serving Cells in this group have the same DRX Active Time, which is determined by the multiple DRX configurations.

In an example, parameters of the multiple DRX configurations may be separately configured or shared by the multiple DRX configurations. In the present disclosure, the parameter shared by the multiple DRX configurations means that the parameter is common (for the multiple DRX configurations). For example, the parameter shared by the multiple DRX configurations may be called common parameters.

In an embodiment, the parameters such as timers are configured for each DRX configuration. Whether or not to separately configure the timer/parameter in each DRX configuration is discussed in case 1 and case 2 below.

### Case 1: Separate Parameter Configuration for the Multiple DRX Configurations for a Serving Cell, a Carrier, or Per Cell Group/Per MAC Entity

In an embodiment, each DRX configuration is considered independent from each other.

For example, for the multiple DRX configurations, the timers of different DRX configurations are separately configured.

If the UE receives the RRC signaling indicating the multiple DRX configurations, the UE's behavior of monitoring of the PDCCH is controlled by multiple parameters/timers. The UE starts/ends the timer(s) of the corresponding DRX configuration regardless of other DRX configurations for a serving cell, a carrier, or per cell group/per MAC entity.

For example, the parameters such as onDurationTimer, drx-LongCycleStartOffset are separately configured for each DRX configuration.

In an embodiment, the UE starts the onDurationTimer after a time offset from the beginning of the subframe which is defined by a corresponding StartOffset in the parameter drx-LongCycleStartOffset with the following equation:

$$[ ( SFN \times 10 ) + subframe number ] modulo ( drx - Cycle ) = StartOffset .$$

In an embodiment, the same periodicity is configured for the multiple separate DRX configurations.

In an embodiment, the following timers of each DRX configuration may be separately configured: onDurationTimer or drx-InactivityTimer or drx-RetransmissionTimer or drx-Retransmission TimerShortTTI or drx-ULRetransmissionTimer or drx-ULRetransmissionTimerShortTTI or mac-ContentionResolutionTimer.

### Case 2: Common Parameter Shared Among Multiple DRX Configurations

In an embodiment, the common parameters may be configured for the multiple DRX configurations and do not need to be configured in the DRX configurations other than the first DRX configuration. In this way, the signaling overhead can be reduced.

In an embodiment, onDurationTimer may be shared by the multiple DRX configurations and defined as: The UE starts drx-onDurationTimer after a time offset from the beginning of the subframe which is defined by the value StartOffset in the parameter drx-LongCycleStartOffset with the following equation

$$[ ( SFN \times 10 ) + subframe number ] modulo ( drx - LongCycle ) = drx - StartOffset .$$

In an embodiment, the same timer may be reused for multiple DRX configurations. For example, one onDurationTimer is allowed to be restarted more than once during one DRX cycle. The UE goes into the DRX-on state when the onDurationTimer is running. In some embodiments, the drx-Cycle can be drx-LongCycle or drx-ShortCycleStartOffset.

In an embodiment, the parameter as follows may be considered as common parameters among multiple configurations:
drx-InactivityTimer: The UE starts or restarts the drx-InactivityTimer when there is a PDCCH indicating new UL/DL transmission.

In an embodiment, the common parameter(s) shared among multiple DRX configurations may comprise at least one of: drx-StartOffset, drx-Retransmission TimerDL, drx-RetransmissionTimerUL, drx-LongCycleStartOffset, drx-ShortCycle, drx-ShortCycleTimer, drx-HARQ-RTT-TimerDL, and drx-HARQ-RTT-TimerUL.

### Case 3: General Procedure for Multiple DRX Configuration

In an embodiment, a gNB configures multiple DRX configurations for a DRX group (e.g. a serving cell, a carrier, or per cell group/per MAC entity). For each DRX configuration, the gNBs configures a plurality of DRX timers including drx-onDurationTimer, drx-InactivityTimer, drx-RetransmissionTimerDL, drx-RetransmissionTimerUL, etc., For a DRX cycle, the start of onDurationTimer is determined via the following equation:

$$[ ( SFN \times 10 ) + subframe number ] modulo ( drx - Cycle ) = StartOffset .$$

Note that the start points of multiple separate onDurationTimers are determined via the formula with separate corresponding drx-StartOffset in multiple DRX configurations.

If a PDCCH is detected by the UE and the PDCCH indicates a new transmission (DL or UL) on a Serving Cell in this DRX group, the UE starts or restarts the drx-InactivityTimer for this DRX group in the first symbol after the end of the PDCCH reception.

In an embodiment, if the active time of a first DRX configuration overlaps with the onDurationTimer configured by a second DRX configuration, the UE stops the timer configured via the first DRX configuration and ensures that the current onDurationTime configured by the second DRX configuration is not impacted.

In an embodiment, a new value associated with the drx-cycle may be introduced.

### Case 1:

In an embodiment, the network configures DRX related parameters, such as drx-LongCycleStartOffset. The parameter indicates the periodicity (drx-LongCycle) in ms, e.g., 10 ms, 20 ms, 32 ms, 40 ms, 60 ms, 64 ms, etc.

### Case 2:

In an embodiment, an integer cycle is obtained based on a frame generation rate (FPS). For example, the FPS on which the integer cycle is obtained based may be 30, 60, 90, 120, 100, 250, or F, wherein F is an integer.

In an embodiment, a mapping relationship between a value of the drx-Cycle and the FPS is as shown in the table below

| index | value of drx-Cycle (ms) | Value of FPS |
|---|---|---|
| 0 | 100 | 30 |
| 1 | 50 | 60 |
| 2 | 100 | 90 |
| 3 | 25 | 120 |

In an embodiment, the gNB configures the drx-Cycle via RRC with one of candidate values “25 ms, 50 ms, 100 ms, reserved”.

In an embodiment, the value of drx-Cycle can be calculated with the following steps:
Formula 1000/fps or fps/1000 is provided,
Execute reduction of the fraction, i.e., 1000/fps=A/B, or fps/1000=B/A, where A, B are integer, and make sure no common divisor between A and B exists. (i.e. A/B, B/A is an irreducible fraction)
The value of drx-LongCycle is configured to be a value of A

In an embodiment, the new value of the drx-Cycle is equal to function (A/B), the function can be rounding, ceiling, flooring.

### Case 3: The New Value of the Drx-Cycle May be Introduced by Adding a New Parameter ‘Offset_Cycle’ in the DRX Configuration.

In an embodiment, the network configures DRX related parameters. In addition to the parameters in the UE DRX-Config, the parameter offset_cycle is included. The parameter offset_cycle is used to enlarge or decrease the value of drx-LongCycle. Thus, a flexible configuration to support various periodicities is provided.

For example, the value of the applied drx-LongCycle is equal to the configured drx-LongCycle in the parameter drx-LongCycleStartOffset, adding offset_cycle. More specifically, in case of FPS=60, the assumed average periodicity for traffic is equal to (1 s/60), the result is nearly 16.6667 ms. The periodicity of DRX and that of traffic are expected to achieve time alignment in of three traffic cycles, actually in 50 ms. Thus, a new value of drx-LongCycle can be achieved by adding a legacy configured drx-LongCycle (e.g. 40) with the value of the parameter offset_cycle (e.g. 10).

### Case 4:

In an embodiment, a Wake up signal can be used to activate or deactivate a DRX group that is configured by using a plurality of DRX configurations.

In some embodiments, the Wake up signal configured by the network can activate or deactivate multiple DRX configurations for a serving cell, a carrier, or per cell group/per MAC entity (i.e. DRX group).

In some embodiments, the Wake up signal can activate or deactivate the multiple DRX configurations in a time period/window (e.g., in a SPS window when a series of SPS (semi-persistent scheduling) resources are configured for data burst transmissions).

In an example, new parameters may be introduced in the DRX configuration (by)

Case 0: Configuring the DRX with a firstCycle and a secondCycle.

FIG. 3 shows a schematic diagram of a DRX configuration according to an embodiment of the present disclosure. As shown in FIG. 3, the UE performs the DRX by using the second cycle within each first cycle.

In the present disclosure, the secondCycleTimer, the numberOfSecondCycle and the firstCycleTimer are defined as the following:
secondCycleTimer: a timer or a DRX cycle;
numberOfSecondCycle: the number of second DRX cycles within the long DRX cycle;
firstCycleTimer: a timer or a DRX cycle

In an embodiment of the secondCycle is configured for a DRX group, the UE performs at least one of:
starting or restarting secondCycleTimer for this DRX group at the same time when firstCycleTimer starts or restarts;
starting or restarting numberOfSecondCycle for this DRX group at the same time when firstCycleTimer starts or restarts;
using the secondCycle for this DRX group.

In an embodiment, if the numberOfSecondCycle for a DRX group expires (e.g. exceeds a corresponding threshold, e.g., the maximum value of numberOfSecondCycle), the UE switches to next firstCycle for this DRX group and performs at least one of:
starting or restarting secondCycleTimer for this DRX group at the same time when firstCycleTimer starts or restarts;
starting or restarting numberOfSecondCycle for this DRX group at the same time when firstCycleTimer starts or restarts;
using the secondCycle for this DRX group.

In an embodiment of the secondCycle being used for a DRX group, the firstCycle is also configured for this DRX group, and

$$[ ( SFN \times 10 ) + subframe number ] modulo ( firstCycle ) = drx - StartOffset ,$$

$$the UE performs at least one of :$$

starting drx-onDurationTimer for this DRX group after drx-SlotOffset from the beginning of the subframe;
restarting drx-onDurationTimer at the beginning of each secondCycleTimer.

In some embodiments, the firstCycle can be drx-LongCycle, and the secondCycle can be drx-ShortCycle.

### Case 1:

In an embodiment, at least one of following new parameters drx-SubcycleTimer, number-of-Subcycle, Sub-cycle-offset are introduced in a DRX configuration.

In this embodiment, the DRX-cycle and the drx-onDurationTimer may be configured via legacy parameters in the DRX configuration.

In an embodiment shown in FIG. 4, in a DRX-cycle, the UE starts the drx-onDurationTimer at the start of the DRX-Cycle, and an offset (configured as the Sub-cycle-offset) is inserted after the end of each sub-cycle. Meanwhile, the number-of-Sub-cycle is started to count the number of the sub-cycles in the DRX-Cycle. In a case, a threshold is the maximum number of configured number-of-Sub-cycle. In addition, the subsequent Sub-cycle is configured without an extra gap. In an embodiment, the value of the Sub-cycle-offset is 1 (ms).

In the embodiment shown in FIG. 4, when a drx-SubcycleTimer is running, the UE goes through a small cycle (i.e. sub-cycle) within which the UE goes to the DRX-on state and goes to the DRX-off state after the drx-onDurationTimer expires. The drx-onDurationTimer restarts in the subsequent Sub-cycles in the DRX-Cycle.

In an embodiment, a new parameter associated with a plurality of offsets (e.g. first-Sub-cycle-offset, second-Sub-cycle-offset, and so-on) is introduced in the DRX configuration.

In this embodiment, the UE stars the drx-onDurationTimer at the start of the DRX-Cycle. If a plurality of offsets are used for a DRX group and the DRX-Cycle is configured, and

$$[ ( SFN \times 10 ) + subframe number ] modulo ( DRX - Cycle ) = drx - StartOffset + offset :$$

the UE starts the drx-onDuration Timer for this DRX group after the drx-SlotOffset from the beginning of the subframe;
wherein the offset=first-Sub-cycle-offset for the start of onDuration of the first sub-cycle, offset=second-Sub-cycle-offset for the start of onDuration of the second sub-cycle, offset=third-Sub-cycle-offset for the start of onDuration of the third sub-cycle, and so on.

In an embodiment, the first-Sub-cycle-offset may be 0.

Note that, the same rules of applying the parameters ‘offset’ mentioned above are used in each DRX-cycle.

In an embodiment, at least one of following new parameters drx-SubcycleTimer or number-of-Subcycle, is introduced in a DRX configuration. The drx-SubcycleTimer is derived from parameters DRX-cycle and the number-of-Subcycle. For example:

$$drx - SubcycleTimer = function ( DRX - cycle , number - of - Subcycle ) ;$$

where the function can be a ceiling function or a flooring function following a division operation. For example, drx-SubcycleTimer=ceiling (DRX-cycle/number-of-Subcycle).

In an embodiment, the number-of-Subcycle is derived from parameters DRX-cycle and the drx-SubcycleTimer. For example:

$$number - of - Subcycle = function ( DRX - cycle , drx - SubcycleTimer ) ;$$

where the function can be a ceiling function or a flooring function following a division operation. For example, number-of-Subcycle=ceiling (DRX-cycle/drx-SubcycleTimer).

### Case 2:

In an embodiment, at least one of following new parameters drx-SubcycleTimer, second-drx-SubcycleTimer, number-of-Subcycle are introduced in a DRX configuration.

In an embodiment of drx-SubcycleTimer expires:
If the number of Subcycle is not exceeded, the UE restarts the drx-onDurationTimer in the first symbol after the expiry of drx-SubcycleTimer, and restarts drx-SubcycleTimer.
If the number of Subcycle is exceeded, the UE operations comprise:
1. using the second drx-SubcycleTimer (e.g., the second drx-SubcycleTimer is 1 less than the drx-Subcycle Timer;
2. if the DRX-LongCycle is not exceeded, restarting the drx-onDuration Timer in the first symbol after the expiry of the second drx-SubcycleTimer, and restarting the second drx-SubcycleTimer;
3. if the DRX-LongCycle is exceeded, using the drx-SubcycleTimer and restart the drx-SubcycleTimer.

FIG. 5 shows a schematic diagram of a switch between different sub DRX-cycles according to an embodiment of the present disclosure.

In an embodiment, several drx-SubcycleTimers are configured in a drx-LongCycle. The second drx-SubcycleTimer may be larger than the drx-SubcycleTimer.

### Case 3: Switch Between Different DRX-Cycles.

In an embodiment, if 2 DRX configurations are configured, the UE may switch between these 2 DRX configurations based on predefined rule(s).

In an embodiment, a new parameter drx-CycleNum is introduced to indicate the number of DRX cycles configured with the DRX configuration. When this counter/timer expires, the DRX cycle configured with the current DRX configuration is stopped, and the DRX cycle configured with another DRX configuration is started.

For example, in a case of 90 fps, the parameter drx-LongCycle is ceil (A/B) for the first DRX configuration and a drx-CycleNum can be configured, e.g, drx-CycleNum=1. On the other hand, for the second DRX configuration, the parameter drx-LongCycle is floor (A/B), and drx-CycleNum can be configured, e.g, drx-CycleNum=9.

### Case 4: Flexible DRX Configuration:

In an embodiment, a DRX group is configured where each DRX cycle is configured within a period, and one or multiple SPS resources are configured within the period.

In an embodiment, for each DRX cycle, the UE starts the drx-OnDurationTimer at the time when the first SPS resource is configured.

In an embodiment, the UE goes to the DRX-off state at the first slot after the time of the last SPS resource in the period being configured.

Note that each above discussed DRX configuration may be used as one of the multiple configurations which is used for one DRX group.

In an example, the granularity of drx-startoffset may be defined more precise (e.g. a unit may be smaller than ms).

In an embodiment, the DRX related parameters configured in the precise granularity may comprise drx-StartOffset.

In an embodiment, the UE starts the drx-onDurationTimer after a time offset from the beginning of the subframe which is defined by the value StartOffset in the parameter drx-LongCycleStartOffset with the following equation:

$$[ ( SFN \times 10 ) + subframe number + slot\_number + symbol\_number ] modulo ( drx - Cycle ) = drx - StartOffset .$$

In some embodiments, the drx-Cycle can be drx-LongCycle or drx-ShortCycleStartOffset.

Note that slot_number+symbol_number may be determined by the FPS. For example, a*2^{μ} slot(s)+b symbol(s) is corresponding to X fps, where u is corresponding to the subcarrier spacing 15 kHz*2^{μ} in a given cell.

In an embodiment of the FPS being 60, the drx-Cycle is assumed to be 50 ms, which may be approximated to 16.67+16.67+16.67 ms. In this embodiment, the slot_number+symbol_number is equal to 1*2^{μ} slot+4 symbol, or 1*2^{μ} slot+5 symbol.

FIG. 6 shows a schematic diagram according to an embodiment of the present disclosure. In the embodiment shown in FIG. 6, the StartOffset is configured to be 1 slot+4 symbols.

FIG. 7 relates to a schematic diagram of a wireless terminal 70 according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 710 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g. messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g. a base station).

FIG. 8 relates to a schematic diagram of a wireless network node 80 according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 810 include but are not limited to a SIM, ROM, flash memory, RAM, hard-disk, and optical data storage device. The communication unit 820 may be a transceiver and is used to transmit and receive signals (e.g. messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g. a user equipment or another wireless network node).

FIG. 9 shows a flowchart of a method according to an embodiment of the present disclosure. The method shown in FIG. 9 may be used in a wireless terminal (e.g. UE) and comprises the following steps:

Step 901: Receive, from a wireless network node, an RRC signaling indicating that a DRX group is configured by using a plurality of DRX configurations.

Step 902: Use DRX parameters configured by using the plurality of DRX configurations to perform a DRX operation for the DRX group.

In FIG. 9, the wireless terminal uses a plurality of DRX configurations for a DRX group. In this embodiment, the UE receiving an RRC signaling, from a wireless network node (e.g. BS, gNB) associated with using the plurality of DRX configurations for the DRX group. Based on the DRX parameters configured by using the plurality of DRX configurations, the wireless terminal performs DRX operation(s) for the DRX group. Note that, start offsets of the plurality of DRX configurations may be different.

In an embodiment, a serving cell, a carrier (e.g. normal carrier or component carrier), a group of serving cells or a MAC entity may be configured in the DRX group (e.g. by the RRC signaling).

In an embodiment, the DRX parameters of the DRX group are configured separately based on each of the plurality of DRX configurations.

In an embodiment, the plurality of DRX configurations has the same DRX cycle.

In an embodiment, a time gap between any two start offsets of the plurality of DRX configurations is larger than a configured onDurationTimer.

In an embodiment, at least one timer associated with the DRX group is configured separately based on each of plurality of DRX configurations. For example, the at least one timer may comprise at least one of a drx-onDurationTimer, a drx-inactivity timer, a drx-retransmission timer, a drx-retransmission timer for short transmission timer interval, a drx-uplink-retransmission timer, a drx-uplink-retransmission timer for short transmission timer interval or a contention resolution timer.

In an embodiment, the plurality of DRX configurations shares at least one common parameter. For example, the at least one common parameter comprises at least one of a drx-onDurationTimer, a drx-inactivity timer, a drx-StartOffset, a drx-RetransmissionDL timer, a drx-RetransmissionUL timer, a drx-LongCycleStartOffset, a drx-ShortCycle a drx-HARQ-RTT-TimerDL or drx-HARQ-RTT-TimerUL.

In an embodiment, a DRX cycle of each of the plurality of DRX configuration is configured to be 25 ms, 50 ms or 100 ms (e.g. a multiple of 25 ms).

In an embodiment, a DRX cycle of each of the plurality of DRX configurations is determined based on:

$$\frac{1000}{fps} = \frac{A}{B} ,$$

where A/B is irreducible fraction,
where fps is a value of FPS and the DRX cycle is configured as A.

In an embodiment, a DRX cycle of each of the plurality of DRX configurations is configured by:

$$drx cycle = round ( \frac{1000}{fps} ) .$$

The FPS may be indicated/comprised in the RRC signaling.

In an embodiment, the wireless terminal may receive, from the wireless network node, a wake up signal of activating or deactivating the DRX group configured by using the plurality of DRX configurations.

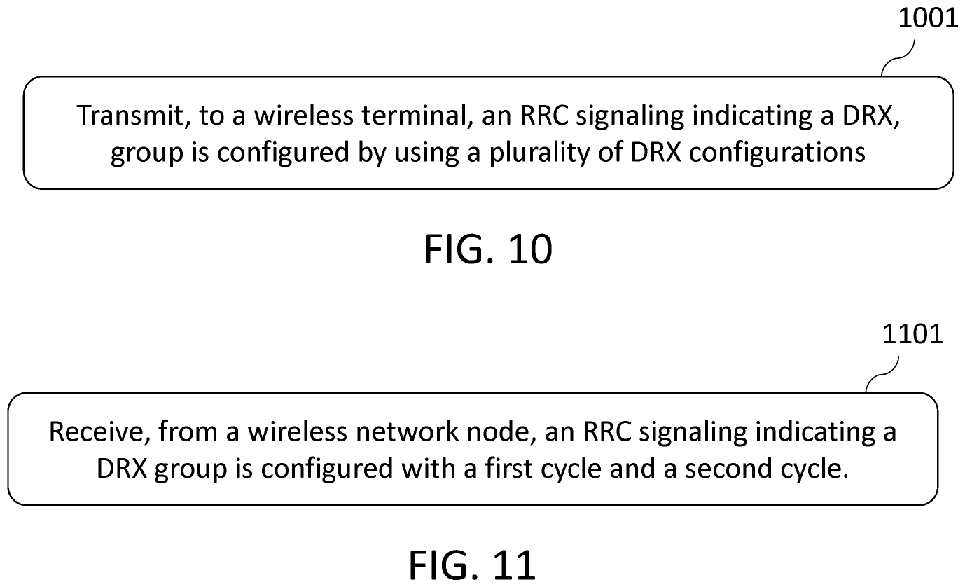

FIG. 10 shows a flowchart of a method according to an embodiment of the present disclosure. The method shown in FIG. 10 may be used in a wireless network node (e.g. BS, gNB) and comprises the following step:

Step 1001: Transmit, to a wireless terminal, an RRC signaling indicating a DRX, group is configured by using a plurality of DRX configurations.

In FIG. 10, the wireless network node indicates that a DRX group is configured by using a plurality of DRX configurations via an RRC signaling. In this embodiment, the start offsets of the plurality of DRX configurations may be different.

In an embodiment, a serving cell, a carrier (e.g. normal carrier or component carrier), a group of serving cells or a MAC entity may be configured in the DRX group (e.g. by the RRC signaling).

In an embodiment, the DRX parameters of the DRX group are configured separately based on each of the plurality of DRX configurations.

In an embodiment, the plurality of DRX configurations has the same DRX cycle.

In an embodiment, a time gap between any two start offsets of the plurality of DRX configurations is larger than a configured onDurationTimer.

In an embodiment, at least one timer associated with the DRX group is configured separately based on each of plurality of DRX configurations. For example, the at least one timer may comprise at least one of a drx-onDurationTimer, a drx-inactivity timer, a drx-retransmission timer, a drx-retransmission timer for short transmission timer interval, a drx-uplink-retransmission timer, a drx-uplink-retransmission timer for short transmission timer interval or a contention resolution timer.

In an embodiment, the plurality of DRX configurations shares at least one common parameter. For example, the at least one common parameter comprises at least one of a drx-onDurationTimer, a drx-inactivity timer, a drx-Slot offset, a drx-RetransmissionDL timer, a drx-RetransmissionUL timer, a drx-LongCycleStartOffset, a drx-ShortCycle a drx-HARQ-RTT-TimerDL or drx-HARQ-RTT-TimerUL.

In an embodiment, a DRX cycle of each of the plurality of DRX configuration is configured to be 25 ms, 50 ms or 100 ms (e.g. a multiple of 25 ms).

In an embodiment, a DRX cycle of each of the plurality of DRX configurations is determined based on:

$$\frac{1000}{fps} = \frac{A}{B} ,$$

where A/B is irreducible fraction,
where fps is a value of FPS and the DRX cycle is configured as A.

In an embodiment, a DRX cycle of each of the plurality of DRX configurations is configured by:

$$drx cycle = function ( \frac{1000}{fps} ) ,$$

wherein the function can be a round function round up function or a round down function.

The FPS may be indicated/comprised in the RRC signaling.

In an embodiment, the wireless terminal may receive, from the wireless network node, a wake up signal of activating or deactivating the DRX group configured by using the plurality of DRX configurations.

FIG. 11 shows a flowchart of a method according to an embodiment of the present disclosure. The method shown in FIG. 11 may be used in a wireless terminal (e.g. UE) and comprises the following step:

Step 1101: Receive, from a wireless network node, an RRC signaling indicating a DRX group is configured with a first cycle and a second cycle.

In FIG. 11, the wireless terminal receives an RRC signaling from a wireless network node (e.g. BS, gNB). The RRC signaling is configured to indicate that a DRX group is configured with a first cycle and a second cycle. The DRX group may comprise a serving cell, a carrier, a group of serving cells or a MAC entity.

In an embodiment, the DRX group is configured with the first cycle and the second cycle by starting a timer of the second cycle and counting the number of second cycles after using the second cycle when starting a timer of the first cycle, wherein the second cycle is used for the DRX group.

In an embodiment, the DRX group is configured with the first cycle and the second cycle by:
when the number of second cycles after using the second cycle exceeds a threshold:
switching to next first cycle, and
starting the timer of the second cycle and counting the number of second cycles after using the second cycle when starting the timer of the next first cycle, wherein the second cycle is used for the DRX group.

In an embodiment, the DRX group is configured with the first cycle and the second cycle by starting a drx-onDurationTimer for the DRX group at a beginning of each second cycle timer.

In an embodiment, the first cycle is drx-LongCycle and the second cycle is drx-ShortCycle. Or, the first cycle is drx-ShortCycle and the second cycle is drx-LongCycle.

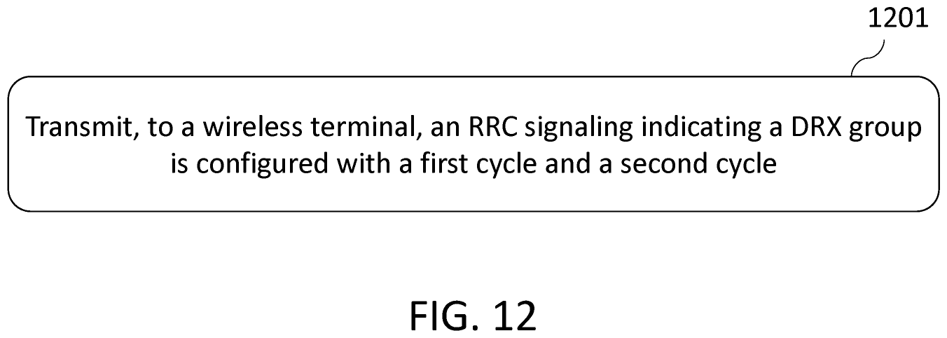

FIG. 12 shows a flowchart of a method according to an embodiment of the present disclosure. The method shown in FIG. 12 may be used in a wireless network node (e.g. BS or gNB) and comprises the following step:

Step 1201: Transmit, to a wireless terminal, an RRC signaling indicating a DRX group is configured with a first cycle and a second cycle.

In FIG. 12, the wireless network node transmits an RRC signaling to a wireless terminal, to indicate that a DRX group is configured with a first cycle and a second cycle. In an embodiment, the DRX group is configured with the first cycle and the second cycle by:
when the number of second cycles after using the second cycle exceeds a threshold:
switching to next first cycle, and
starting the timer of the second cycle and counting the number of second cycles after using the second cycle when starting the timer of the next first cycle, wherein the second cycle is used for the DRX group.

In an embodiment, the DRX group is configured with the first cycle and the second cycle by starting a drx-onDurationTimer for the DRX group at a beginning of each second cycle timer.

In an embodiment, the first cycle is drx-LongCycle and the second cycle is drx-ShortCycle. Or, the first cycle is drx-ShortCycle and the second cycle is drx-LongCycle.

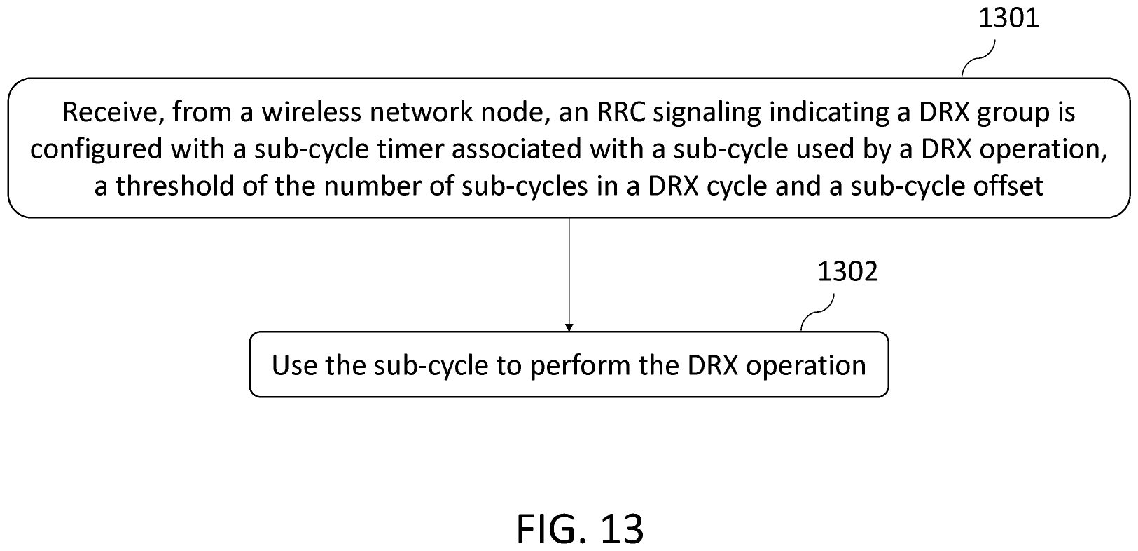

FIG. 13 shows a flowchart of a method according to an embodiment of the present disclosure. The method shown in FIG. 13 may be used in a wireless terminal (e.g. UE) and comprises the following steps:

Step 1301: Receive, from a wireless network node, an RRC signaling indicating a DRX group is configured with a sub-cycle timer associated with a sub-cycle used by a DRX operation, a threshold of the number of sub-cycles in a DRX cycle and a sub-cycle offset.

Step 1302: Use the sub-cycle to perform the DRX operation.

In FIG. 13, the wireless terminal receives, from a wireless network node, an RRC signaling indicating that a sub-cycle timer associated with a sub-cycle used by a DRX operation, a threshold of the number of sub-cycles in a DRX cycle and a sub-cycle offset. According to RRC signaling, the wireless terminal uses the sub-cycle to perform the DRX operation.

For example, the wireless terminal uses the sub-cycle to perform the DRX operation by:
starting the sub-cycle timer and counting the number of sub-cycles in a first DRX cycle at a start of the first DRX cycle,
restarting the sub-cycle timer the sub-cycle offset after the sub-cycle timer expires,
starting a drx-onDurationTimer at a beginning of each sub-cycle timer, and
starting a second DRX cycle after the number of sub-cycles in the first DRX cycle exceeds the threshold.

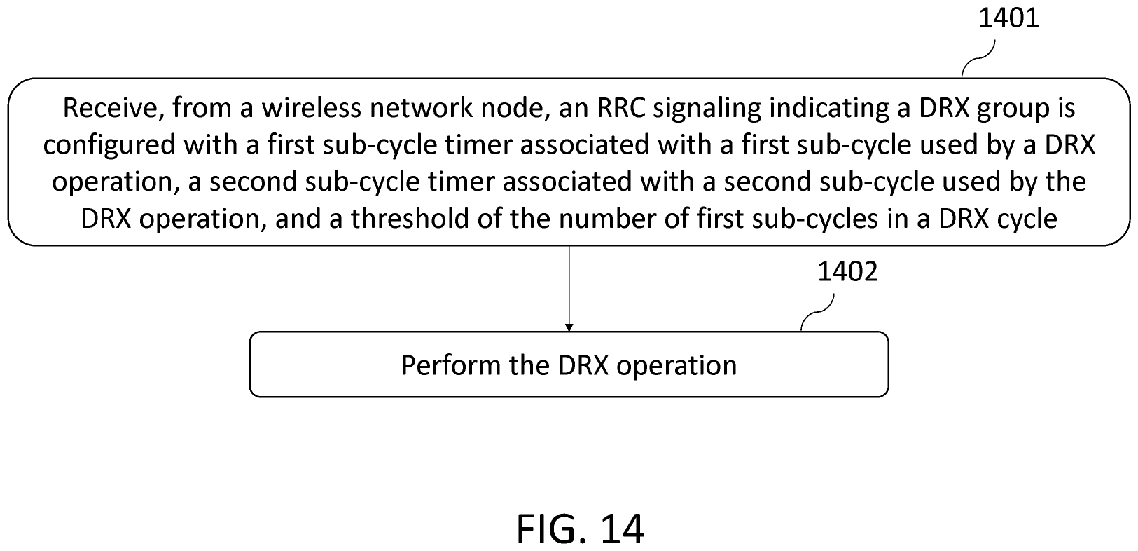

FIG. 14 shows a flowchart of a method according to an embodiment of the present disclosure. The method shown in FIG. 14 may be used in a wireless terminal (e.g. UE) and comprises the following steps:

Step 1401: Receive, from a wireless network node, an RRC signaling indicating a DRX group is configured with a first sub-cycle timer associated with a first sub-cycle used by a DRX operation, a second sub-cycle timer associated with a second sub-cycle used by the DRX operation, and a threshold of the number of first sub-cycles in a DRX cycle.

Step 1402: Perform the DRX operation.

In FIG. 14, the wireless terminal receives an RRC signaling from a wireless network node. The RRC signaling is configured to indicate that a DRX group is configured with a first sub-cycle timer associated with a first sub-cycle used by a DRX operation, a second sub-cycle timer associated with a second sub-cycle used by the DRX operation, and a threshold of the number of first sub-cycles in a DRX cycle. Based on the RRC signaling, the wireless terminal performs the DRX operation. For example, the wireless terminal performs the DRX operation by:
1. starting a drx-onDurationTimer, the first sub-cycle timer and counting the number of first sub-cycles in a DRX cycle at a start of the DRX cycle,
2. if the first sub-cycle timer expires and the number of first sub-cycles in the first DRX cycle does not exceed the threshold:
2.1 restarting the drx-onDurationTimer in the first symbol after the first sub-cycle timer expires, and
2.2 restarting the first sub-cycle timer,
3. if the first sub-cycle timer expires and the number of first sub-cycles in the first DRX cycle exceeds the threshold:
3.1 starting the second sub-cycle timer and the drx-onDuration Timer,
3.2 restarting the drx-onDurationTimer in the first symbol after the second sub-cycle timer expires and restarting the second sub-cycle time when in the DRX-cycle, and
3.3 switching to (use) a first sub-cycle after the DRX-cycle ends.

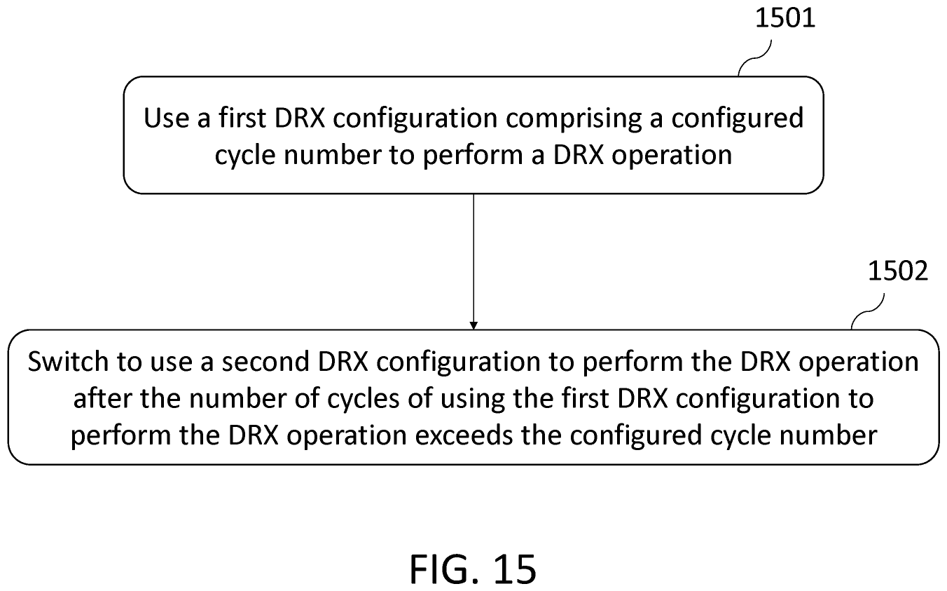

FIG. 15 shows a flowchart of a method according to an embodiment of the present disclosure. The method shown in FIG. 15 may be used in a wireless terminal (e.g. UE) and comprises the following steps:

Step 1501: Use a first DRX configuration comprising a configured cycle number to perform a DRX operation.

Step 1502: Switch to use a second DRX configuration to perform the DRX operation after the number of cycles of using the first DRX configuration to perform the DRX operation exceeds the configured cycle number.

In FIG. 15, the wireless terminal uses a first DRX configuration to perform a DRX operation. The first DRX configuration comprises a first configured cycle number, which indicates the number of times of using the first DRX configuration to perform the DRX operation. After the number of cycles of using the first DRX configuration to perform the DRX operation exceeds the first configured cycle number, the wireless terminal switches to use a second DRX configuration to perform the DRX operation.

Note that the second DRX configuration may also comprises a second configured cycle number. After the number of cycles of using the second DRX configuration to perform the DRX operation exceeds the second configured cycle number, the wireless terminal switches to use a third DRX configuration or the first DRX configuration to perform the DRX operation.

In an embodiment, the first DRX configuration, the second DRX configuration, and/or the third DRX configuration may be indicated by an RRC signaling received from a wireless network node (e.g. BS or gNB).

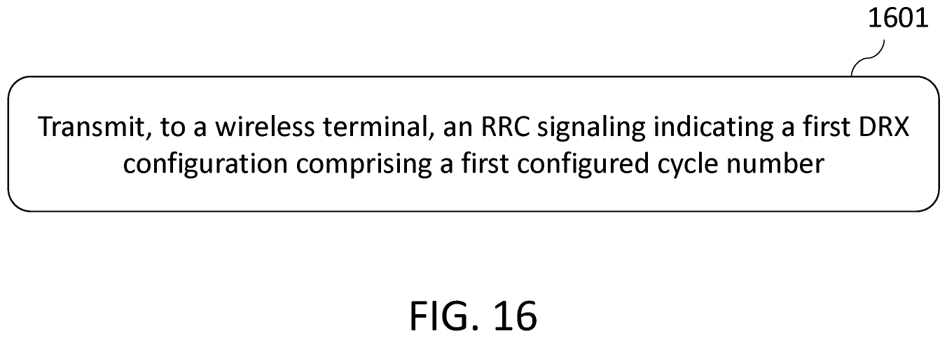

FIG. 16 shows a flowchart of a method according to an embodiment of the present disclosure. The method shown in FIG. 16 may be used in a wireless network node (e.g. BS or gNB) and comprises the following step:

Step 1601: Transmit, to a wireless terminal, an RRC signaling indicating a first DRX configuration comprising a first configured cycle number.

In FIG. 16, the wireless network node transmits an RRC signaling to a wireless terminal (e.g. UE). The RRC signaling is associated with a first DRX configuration comprising a first configured cycle number. The first configured cycle number indicates the number of cycles of using the first DRX configuration to perform a DRX operation before switching to use a second DRX configuration to perform the DRX operation.

In the present disclosure, the parameter(s) in each DRX configuration may be determined based on at least one variable having a time unit smaller than a subframe (e.g. a slot and/or a symbol).

For example, the parameter(s) comprises at least one of a start offset for a long cycle (e.g. drx-LongCycleStartOffset) or a start offset for a short cycle (e.g. drx-ShortCycleStartOffset).

In an embodiment, the start offset for the long cycle or the start offset for the short cycle is determined by:

$$[ ( SFN \times 10 ) + subframe number + slot number + symbol number ] modulo ( drx cycle )$$

wherein SFN is a system frame number.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, a radio resource control, RRC, signaling indicating that a discontinuous reception, DRX, group is configured by using a plurality of DRX configurations, and
using DRX parameters configured by using the plurality of DRX configurations to perform a DRX operation for the DRX group,
wherein start offsets of the plurality of DRX configurations are different.

2. The wireless communication method of claim 1, wherein the RRC signaling configures a serving cell, a carrier, a group of serving cells or a media access control, MAC, entity in the DRX group configured by using the plurality of DRX configurations.

3. The wireless communication method of claim 2, wherein the DRX parameters of the DRX group are configured separately based on each of the plurality of DRX configurations.

4. (canceled)

5. The wireless communication method of claim 1, wherein a time gap between any two start offsets of the plurality of DRX configurations is larger than a configured onDurationTimer.

6. (canceled)

7. The wireless communication method of claim 1, wherein the plurality of DRX configurations shares at least one common parameter.

8. The wireless communication method of claim 7, wherein the at least one common parameter comprises at least one of a drx-onDurationTimer or a drx-inactivity timer.

9. (canceled)

10. The wireless communication method of claim 1, wherein a DRX cycle of each of the plurality of DRX configurations is determined based on:
$$\frac{1000}{fps} = \frac{A}{B} ,$$
where A/B is irreducible fraction
wherein fps is a value of frames per second and the DRX cycle is configured as A.

11. The wireless communication method of claim 1, wherein a DRX cycle of each of the plurality of DRX configurations is configured by:
$$drx cycle = function ( \frac{1000}{fps} ) ,$$
wherein the function is a round function, a round up function or a round down function.

12. The wireless communication method of claim 1, further comprising:
receiving, from the wireless network node, a wake up signal of activating or deactivating the DRX group configured by using the plurality of DRX configurations.

13. A wireless communication method for use in a wireless network node, the method comprising:
transmitting, to a wireless terminal, a radio resource control, RRC, signaling indicating that a discontinuous reception, DRX, group is configured by using a plurality of DRX configurations,
wherein start offsets of the plurality of DRX configurations are different.

14. The wireless communication method of claim 13, wherein the RRC signaling configures a serving cell, a carrier, a group of serving cells or a media access control, MAC, entity in the DRX group.

15. (canceled)

16. The wireless communication method of claim 13, wherein a time gap between any two start offsets of the plurality DRX configurations is larger than a configured onDurationTimer.

17. The wireless communication method of claim 13, wherein the plurality of DRX configurations shares at least one common parameter.

18. (canceled)

19. (canceled)

20. The wireless communication method of claim 13, wherein a drx cycle of each of the plurality of DRX configurations is determined based on:
$$\frac{1000}{fps} = \frac{A}{B} ,$$
where A/B is irreducible fraction,
wherein fps is a value of frames per second and the DRX cycle is configured as A.

21. The wireless communication method of claim 13, wherein a DRX cycle of each of the plurality of DRX configurations is configured by:
$$drx cycle = function ( \frac{1000}{fps} ) ,$$
wherein the function is a round function round up function or a round down function.

22. The wireless communication method of claim 13, further comprising:
transmitting, to the wireless terminal, a wake up signal of activating or deactivating the DRX group configured by using the plurality of DRX configurations.

23-41. (canceled)

42. A wireless terminal, comprising:
a communication unit, configured to receive, from a wireless network node, a radio resource control, RRC, signaling indicating that a discontinuous reception, DRX, group is configured by using a plurality of DRX configurations, and
a processor, configured to use DRX parameters configured by using the plurality of DRX configurations to perform a DRX operation for the DRX group,
wherein start offsets of the plurality of DRX configurations are different.

43. (canceled)

44. A wireless network node, comprising:
a communication unit, configured to perform the operations of the wireless communication method recited in claim 13.

45-49. (canceled)

50. A computer program product comprising a computer-readable program medium code stored thereupon, the code, when executed by a processor of a wireless terminal, causing the processor to implement a wireless communication method recited in claim 1.

51. A computer program product comprising a computer-readable program medium code stored thereupon, the code, when executed by a processor of a wireless network node, causing the processor to implement a wireless communication method recited in claim 13.
